(19) United States
(12) Patent Application Publication
(10) Pub. No.: US 2025/0303917 A1
(43) Pub. Date: Oct. 2, 2025

(54) TECHNIQUES FOR ENSURING PROPULSION SYSTEM ENABLEMENT AND LOW VOLTAGE SYSTEM PROTECTION BY SUPERVISING THERMAL DEVICES IN ELECTRIFIED VEHICLES

(71) Applicant: FCA US LLC, Auburn Hills, MI (US)

(72) Inventors: Abhilash Gudapati, Troy, MI (US); Rudolph Kharpuri, Auburn Hills, MI (US)

(21) Appl. No.: 18/624,425

(22) Filed: Apr. 2, 2024

(51) Int. Cl. B60L 58/12; B60L 53/22

(52) U.S. Cl. CPC B60L 58/12; B60L 53/22; B60L 2210/10; B60L 2240/547

(57) ABSTRACT

A low voltage management method for an electrified vehicle includes a supervisory controller connected to a set of low voltage thermal systems via a local interconnect network (LIN) bus. When a low voltage of a low voltage system configured to selectively power the set of low voltage thermal systems does not satisfy a first threshold but satisfies a different second threshold, the supervisory controller enables a high voltage system by commanding a contactor of the high voltage system to close. When a direct current to direct current (DC-DC) converter associated with the high voltage system is efficiently supporting a set of low voltage loads and the low voltage system is not determined to be in a malfunctioned state, the supervisory controller enables the set of low voltage thermal systems.

### FIELD

The present application generally relates to electrified vehicle low voltage system management and, more particularly, to techniques for ensuring propulsion system enablement and low voltage system protection by supervising thermal devices in electrified vehicles.

### BACKGROUND

The low voltage (e.g., 12V) battery on an electrified vehicle is at risk for significant energy drainage, particularly during ignition-off states. Thermal system components of the electrified vehicle, such as fans/pumps, consume significant amounts of energy. Improper load management on the low voltage battery could result in there being insufficient energy for various needs, such as engine cranking and high voltage system enablement. This excessive draining of the low voltage battery could also potentially result in damage or degradation to the low voltage battery and to other components, such as low voltage accessory components (e.g., low voltage thermal systems) and/or high voltage contactors welding during their actuation. Accordingly, while such conventional electrified vehicle low voltage management systems and methods do work for their intended purpose, there exists an opportunity for improvement in the relevant art.

### SUMMARY

According to one example aspect of the invention, a low voltage management system for an electrified vehicle is presented. In one exemplary implementation, the system comprises an intelligent battery sensor configured to monitor a low voltage of a low voltage system of the electrified vehicle, the low voltage system being configured to selectively power a set of low voltage loads including a set of low voltage thermal systems and being connected to a high voltage system of the electrified vehicle via a direct current to direct current (DC-DC) converter, and a supervisory controller connected to the intelligent battery sensor and to the set of low voltage thermal systems via a local interconnect network (LIN) bus and to, when the low voltage satisfies a first threshold, enable the set of low voltage thermal systems, when the low voltage does not satisfy the first threshold but satisfies a different second threshold, enable the high voltage system by commanding a contactor of the high voltage system to close, and when the DC-DC converter is efficiently supporting the set of low voltage loads and the low voltage system is not determined to be in a malfunctioned state, enable the set of low voltage thermal systems.

In some implementations, the set of low voltage thermal systems comprises at least one of a fan and a pump. In some implementations, the supervisory controller is further configured to, in response to a valid wakeup request, enable the LIN bus, and determine whether there is a valid reason to enable the high voltage system. In some implementations, when there is not a valid reason to enable the high voltage system, the supervisory controller is further configured to set a shutdown timer and then powerdown upon expiration of the shutdown timer. In some implementations, the first threshold includes acceptable limits for the low voltage system. In some implementations, the supervisory controller is further configured to determine whether the low voltage battery is being supported by the DC-DC converter and whether the low voltage satisfies a third threshold. In some implementations, the third threshold is indicative of the malfunctioned state of the low voltage battery. In some implementations, the third threshold is an amount of change of the low voltage. In some implementations, the electrified vehicle further comprises a set of high voltage thermal systems that are powered by the high voltage system when enabled.

According to another example aspect of the invention, a low voltage management method for an electrified vehicle is presented. In one exemplary implementation, the method comprises providing an intelligent battery sensor configured to monitor a low voltage of a low voltage system of the electrified vehicle, the low voltage system being configured to selectively power a set of low voltage loads including a set of low voltage thermal systems and being connected to a high voltage system of the electrified vehicle via a DC-DC converter, providing a supervisory controller connected to the intelligent battery sensor and to the set of low voltage thermal systems via a LIN bus, when the low voltage satisfies a first threshold, enabling, by the supervisory controller, the set of low voltage thermal systems, when the low voltage does not satisfy the first threshold but satisfies a different second threshold, enabling, by the supervisory controller, the high voltage system by commanding a contactor of the high voltage system to close, and when the DC-DC converter is efficiently supporting the set of low voltage loads and the low voltage system is not determined to be in a malfunctioned state, enabling, by the supervisory controller, the set of low voltage thermal systems.

In some implementations, the set of low voltage thermal systems comprises at least one of a fan and a pump. In some implementations, the method further comprises, in response to a valid wakeup request, enabling, by the supervisory controller, the LIN bus, and determining, by the supervisory controller, whether there is a valid reason to enable the high voltage system. In some implementations, when there is not a valid reason to enable the high voltage system, the method further comprises setting, by the supervisory controller, a shutdown timer and then powering down. By the supervisory controller, upon expiration of the shutdown timer. In some implementations, the first threshold includes acceptable limits for the low voltage system. In some implementations, the method further comprises determining, by the supervisory controller, whether the low voltage battery is being supported by the DC-DC converter and whether the low voltage satisfies a third threshold. In some implementations, the third threshold is indicative of the malfunctioned state of the low voltage battery. In some implementations, the third threshold is an amount of change of the low voltage. In some implementations, the electrified vehicle further comprises a set of high voltage thermal systems that are powered by the high voltage system when enabled.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an example low voltage management system according to the principles of the present application;

FIG. 2 is a functional block diagram of an example architecture for the example low voltage management system according to the principles of the present application; and

FIG. 3 is a flow diagram of an example low voltage management method for an electrified vehicle according to the principles of the present application.

### DESCRIPTION

As previously discussed, thermal system components of an electrified vehicle, such as fans/pumps, consume significant amounts of energy. Improper load management on the low voltage battery could result in there being insufficient energy for various needs, such as engine cranking and high voltage system enablement. This excessive draining of the low voltage battery could also potentially result in damage or degradation to the low voltage battery and to other components, such as low voltage accessory components (e.g., low voltage thermal systems) and/or high voltage contactors welding during their actuation. For example, the low voltage system (and, in turn, the low voltage thermal systems) could be unintendedly woken up in response to customer actions such as opening vehicle doors or using a third-party application for managing functions of the electrified vehicle (e.g., charging).

Accordingly, improved low voltage system management techniques for electrified vehicles are presented herein, which provide improved protection of the electrified vehicle's low voltage system and other components (thermal systems, the high voltage system, etc.), while also ensuring operation of the electrified vehicle's propulsion system. These techniques utilize a vehicle mode manager sub-system (VMMS), which could be a specific software routine executed by the electronic powertrain supervisory controller (“ePT SC”).

The VMMS monitors the energy (e.g., state of charge, or SOC) of the low voltage system and, when it is below a calibratable threshold indicative of a normal value, the VMMS enables the high voltage system. This requires enough low voltage (12V) power to close the contactor(s) and connect the high voltage battery to the high voltage bus. A direct current to direct current (DC-DC) converter can then use the high voltage to support the low voltage battery/bus. For any reasons that the high voltage system cannot be enabled, the VMMS will not enable low voltage thermal systems as they are unsupportable by the low voltage battery/bus alone. In the case of a very bad/poor health low voltage battery, the high voltage system (via the DC-DC converter) could fully support the low voltage bus and the low voltage thermal systems. Potential benefits include improved customer satisfaction and decreased warranty/replacement costs of electrified vehicle components. Another potential benefit is that this design protects for a case where the customer is attempting to “jump-start” the low voltage battery of the electrified vehicle via another power source (e.g., another energy system of another vehicle). In such jump-start scenarios, the VMMS will arbitrate the low voltage system health in order to correctly enable the high energy-consuming low voltage thermal components.

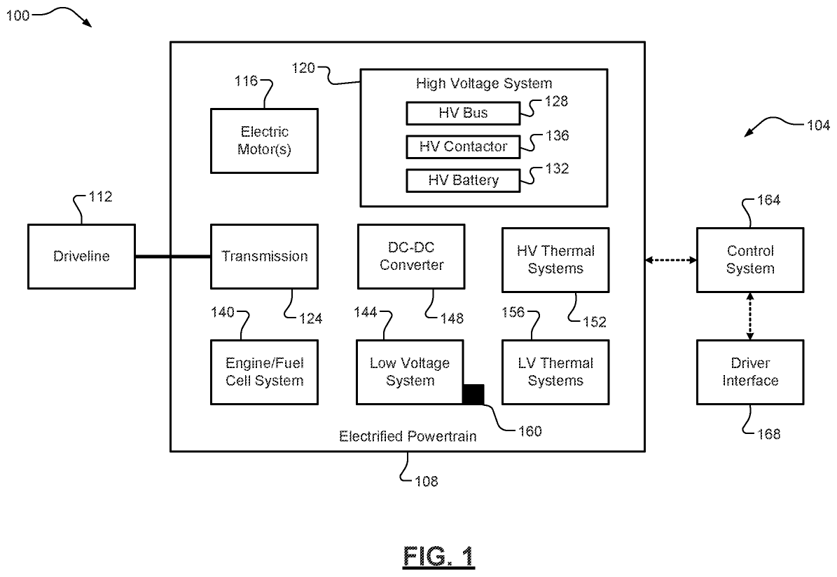

Referring now to FIG. 1, a functional block diagram of an electrified vehicle 100 having an example control and thermal management system 104 according to the principles of the present application is illustrated. The electrified vehicle 100 generally comprises an electrified powertrain 108 configured to generate and transfer torque to a driveline 112 for vehicle propulsion. Specifically, the electrified powertrain 108 includes one or more electric motors 116 (e.g., electric traction motors) that are selectively provided with high voltage from a high voltage (HV) system 120. The torque generated by the electric motor(s) 116 is transferred to the driveline 112 via a transmission 124, such as a multi-speed automatic transmission. The HV system 120 includes a HV bus 128 that is connected to the electric motor(s) 116 (e.g., a three-phase inverter, not shown, therebetween) and to a HV battery pack or system 132, with one or more contactors 136 arranged therebetween. In some implementations, the electrified powertrain 108 includes another energy source, such as an internal combustion engine and/or a fuel cell system 140. The electrified powertrain 108 also includes a low voltage (LV) system 144 (e.g., a 12V battery) and a DC-DC converter 148 for stepping up/down supplied voltage, such as for supporting/recharging the LV system 144 using the HV system 120. An intelligent battery sensor 160 or other suitable device monitors parameters (e.g., energy) of the LV system 144.

The electrified powertrain 108 also includes a set of HV thermal systems 152 and a set of LV thermal systems 156, which could be only some LV loads of a larger set of LV loads of the electrified vehicle 100 (e.g., other LV loads could include clusters/gauges, displays, lights, and the like). While shown as part of the electrified powertrain 108, it will be appreciated that these thermal systems 152, 156 could be separate from the electrified powertrain 108. Each set of thermal systems 152, 156 includes low or high voltage powered thermal actuators or components (heaters, chillers, etc.), such as airflow control devices (fans, active vents/shutters, etc.) and fluid control devices (radiators, pumps/compressors/evaporators, etc.) that are configured to perform heat exchanging functions on a target medium. The electrified vehicle 100 and, more particularly, the electrified powertrain 108 is controlled by a control system 164. The control system 164 controls operation of the electrified vehicle 100 and, in particular, controls the electrified powertrain 108 to generate and transfer a desired amount of torque to the driveline 112 to satisfy a driver torque request, which could be provided by a driver of the electrified vehicle 100 via a driver interface 168 (e.g., an accelerator pedal). The control system 164 is also configured to perform at least a portion of the low voltage management techniques of the present application, which will now be described in greater detail.

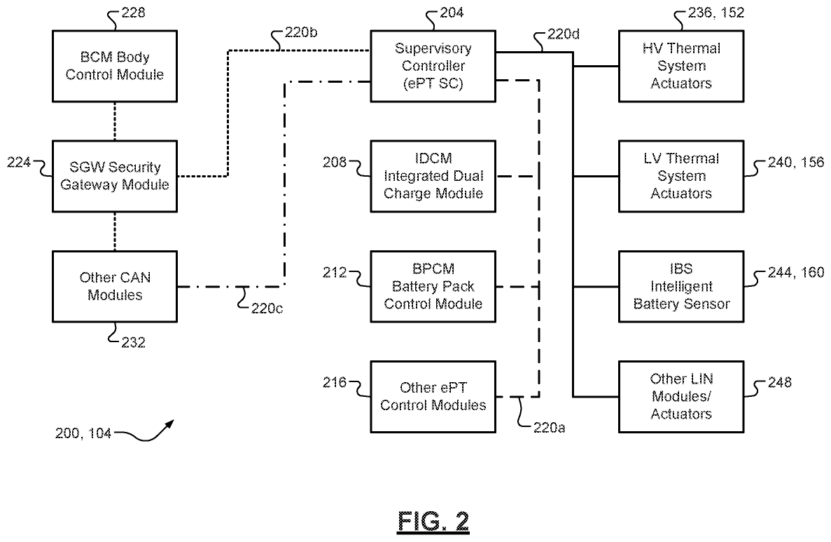

Referring now to FIG. 2, a functional block diagram of an example architecture 200 for the electrified vehicle control and thermal management system 104 (hereinafter, “system 200”) according to the principles of the present application is illustrated. The system 200 includes an electrified powertrain supervisory controller (ePT SC) 204 that is configured to control operation of the electrified powertrain 108 and also to operate selectively as a vehicle mode management sub-system (VMMS) as part of the techniques of the present application. The ePT SC 204 is in communication with other ePT controllers or modules, including an integrated dual charging module (IDCM) 208, a battery pack control module (BPCM) 212, and other ePT control modules 216 (an engine control module (ECM), a fuel cell propulsion system (FCPS) module, etc.) via a first CAN bus 220a (also referred to as an “ePT bus”). The ePT SC is also configured to communicate with a security gateway (SGW) module 224 via a second CAN bus 220b. The SGW module 224 acts as a supervisor module for various activities, including, but not limited to, firmware over-the-air (FOTA) flash update control and, in some cases, as part of the VMMS for purposes of the present application. The SGW module 224 could also be configured to communicate with other CAN modules, such as a body control module (BCM) 228 and other CAN modules (telematics/entertainment module(s), a radio frequency hub module (RFHM), etc.) 232 via the CAN bus 220b and/or some of these other CAN modules 232 could be in direct communication with the ePT SC 204 via a third CAN bus 220c.

The ePT SC 204 is also configured to communicate with a set of HV thermal system actuators 236 (e.g., of the HV thermal systems 152), a set of LV thermal system actuators 240 (e.g., of the LV thermal systems 156), and an intelligent battery sensor (IBS) 244, 160 via one or more respective LIN buses 220d. It will be appreciated that the ePT SC 204 could also be configured to communicate with other LIN modules/actuators 248 (lock actuators, sensors, etc.) via the one or more LIN buses 220d. In response to a valid wakeup of the electrified vehicle 100, the ePT SC 204 wakes up and starts execution of its basic software (SW) and enables the LIN bus 220d. In some implementations, the ePT SC 204 then transitions or hands-off control to the VMMS routine. The ePT SC 204 then determines whether the voltage of the LV system 144 satisfies a first threshold and, when true, the ePT SC 204 enables the set of LV thermal systems 156, 240. When the voltage does not satisfy the first threshold but does satisfy a different second threshold, the ePT SC 204 enables the HV system 120 by commanding the HV contactor 136 to close. Lastly, when the DC-DC converter 148 is determined to be efficiently supporting the set of LV loads and the LV system 144 is not determined to be in a malfunctioned state (e.g., a bad 12V battery), the ePT SC 204 enables the set of LV thermal systems. This strategy ensures the LV system 144 has sufficient stored energy for propulsion enablement functions while also avoiding potential damage to the LV system 144, the HV system 120, and other components (e.g., the set of LV thermal systems 156).

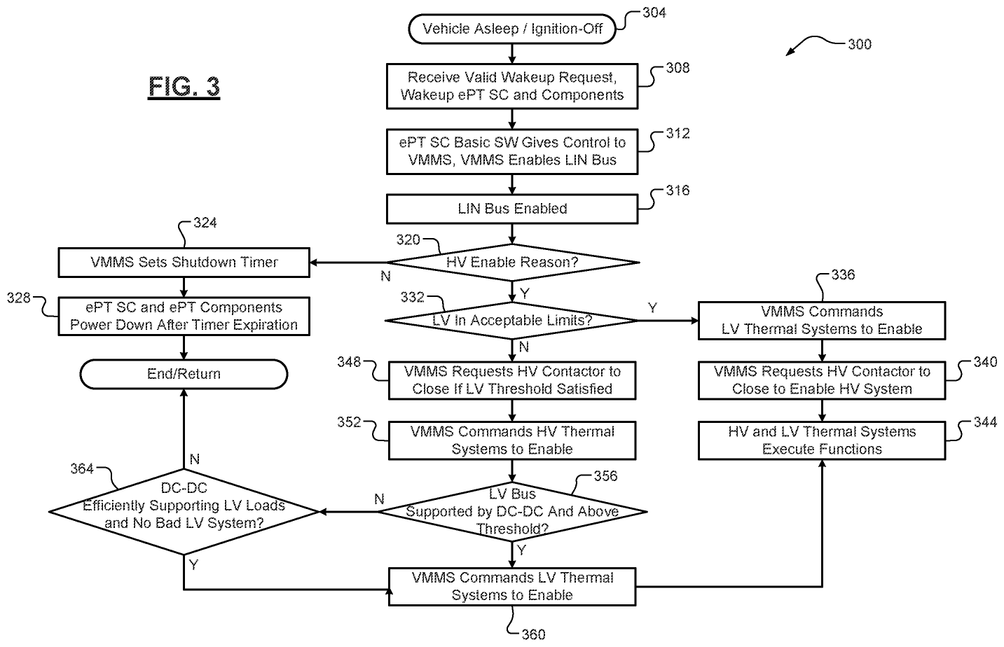

Referring now to FIG. 3, a flow diagram of an example control and thermal management method 300 for an electrified vehicle according to the principles of the present application is illustrated. While the electrified vehicle 100 and its components are specifically referenced for descriptive/illustrative purposes, it will be appreciated that the method 300 could be applicable to any suitably configured electrified vehicle. The method 300 begins at 304 where the electrified vehicle 100 is asleep (an ignition-off status). At 308, a valid wakeup request for the electrified vehicle 100 is received and the ePT SC 204 wakes up itself and other ePT components (e.g., on the ePT bus 220a). At 312, the ePT SC 204 basic SW gives temporary control to the VMMS routine and the VMMS enables the LIN bus 220d. At 316, the LIN bus 220d is enabled. At 320, it is determined whether a reason exists to enable the HV system 120. When false, the method 300 proceeds to 324 where the VMMS sets a shutdown timer and then, at 328, the ePT SC and other ePT components (the IDCM 208, the BPCM 212, etc.) shutdown upon expiration of the timer and the method 300 then ends or returns to 304. When true, the method 300 proceeds to 332. At 332, the VMMS determines whether the voltage of the LV system 144 is within acceptable limits (e.g., satisfying a first threshold). This first threshold or the acceptable limits represent voltages of the LV system 144 where the LV system 144 is able to (with a sufficient degree of confidence) handle powering of the set of LV thermal systems 156 while also maintaining enough energy for subsequent propulsion enablement activities. When true, the method 300 proceeds to 336. When false, the method 300 proceeds to 348.

At 336, the VMMS commands the set of LV thermal systems 156 to enable. At 340, the VMMS requests the HV contactor 136 to close to enable the HV system 120. At 344, the sets of LV and HV thermal systems 152, 156 are able to both be enabled and execute their respective functions and, upon expiration/completion of these functions, the ePT SC 204 and the ePT components powerdown and the method 300 then ends or returns to 304. At 348, the VMMS requests the HV contactor 136 to close if a second threshold for the voltage of the LV system 144 is satisfied. This second threshold is different than the first threshold (the acceptable limits) and should have a lesser magnitude as it only corresponds to a voltage or an amount of energy necessary for the LV system 144 to properly (i.e., without malfunction, such as welding) close the HV contactor 136 and enable the HV system 144. At 352, the VMMS commands the set of HV thermal systems 152 to enable. At 356, the VMMS determines whether the LV system 144 (e.g., a LV bus) is being supported by the DC-DC converter 148 and the voltage of the LV system 144 satisfies (e.g., is above) a third threshold. When true, the method 300 proceeds to 360 where the VMMS commands the set of LV thermal systems 156 to enable and the method 300 proceeds to 344 and ends. When false, the method 300 proceeds to 364. At 364, the VMMS determines whether the DC-DC converter 148 is efficiently supporting the set of LV loads of the electrified vehicle 100 and the third threshold does not indicate that the LV system 144 is in a malfunctioned state (e.g., a bad 12V battery). For example, an amount of change of the third threshold could be monitored as part of this determination. When true, the method 300 proceeds to 360. When false, the ePT SC 204 and the ePT components powerdown and the method 300 ends or returns to 304.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A low voltage management system for an electrified vehicle, the system comprising:
an intelligent battery sensor configured to monitor a low voltage of a low voltage system of the electrified vehicle, the low voltage system being configured to selectively power a set of low voltage loads including a set of low voltage thermal systems and being connected to a high voltage system of the electrified vehicle via a direct current to direct current (DC-DC) converter; and
a supervisory controller connected to the intelligent battery sensor and to the set of low voltage thermal systems via a local interconnect network (LIN) bus and to:
when the low voltage satisfies a first threshold, enable the set of low voltage thermal systems;
when the low voltage does not satisfy the first threshold but satisfies a different second threshold, enable the high voltage system by commanding a contactor of the high voltage system to close; and
when the DC-DC converter is efficiently supporting the set of low voltage loads and the low voltage system is not determined to be in a malfunctioned state, enable the set of low voltage thermal systems.

2. The system of claim 1, wherein the set of low voltage thermal systems comprises at least one of a fan and a pump.

3. The system of claim 1, wherein the supervisory controller is further configured to:
in response to a valid wakeup request, enable the LIN bus; and
determine whether there is a valid reason to enable the high voltage system.

4. The system of claim 3, wherein when there is not a valid reason to enable the high voltage system, the supervisory controller is further configured to set a shutdown timer and then powerdown upon expiration of the shutdown timer.

5. The system of claim 3, wherein the first threshold includes acceptable limits for the low voltage system.

6. The system of claim 3, wherein the supervisory controller is further configured to determine whether the low voltage battery is being supported by the DC-DC converter and whether the low voltage satisfies a third threshold.

7. The system of claim 6, wherein the third threshold is indicative of the malfunctioned state of the low voltage battery.

8. The system of claim 7, wherein the third threshold is an amount of change of the low voltage.

9. The system of claim 1, wherein the electrified vehicle further comprises a set of high voltage thermal systems that are powered by the high voltage system when enabled.

10. A low voltage management method for an electrified vehicle, the method comprising:
providing an intelligent battery sensor configured to monitor a low voltage of a low voltage system of the electrified vehicle, the low voltage system being configured to selectively power a set of low voltage loads including a set of low voltage thermal systems and being connected to a high voltage system of the electrified vehicle via a direct current to direct current (DC-DC) converter;
providing a supervisory controller connected to the intelligent battery sensor and to the set of low voltage thermal systems via a local interconnect network (LIN) bus;
when the low voltage satisfies a first threshold, enabling, by the supervisory controller, the set of low voltage thermal systems;
when the low voltage does not satisfy the first threshold but satisfies a different second threshold, enabling, by the supervisory controller, the high voltage system by commanding a contactor of the high voltage system to close; and
when the DC-DC converter is efficiently supporting the set of low voltage loads and the low voltage system is not determined to be in a malfunctioned state, enabling, by the supervisory controller, the set of low voltage thermal systems.

11. The method of claim 10, wherein the set of low voltage thermal systems comprises at least one of a fan and a pump.

12. The method of claim 10, further comprising:
in response to a valid wakeup request, enabling, by the supervisory controller, the LIN bus; and
determining, by the supervisory controller, whether there is a valid reason to enable the high voltage system.

13. The method of claim 12, wherein when there is not a valid reason to enable the high voltage system, the method further comprises setting, by the supervisory controller, a shutdown timer and then powering down. By the supervisory controller, upon expiration of the shutdown timer.

14. The method of claim 12, wherein the first threshold includes acceptable limits for the low voltage system.

15. The method of claim 12, further comprising determining, by the supervisory controller, whether the low voltage battery is being supported by the DC-DC converter and whether the low voltage satisfies a third threshold.

16. The method of claim 15, wherein the third threshold is indicative of the malfunctioned state of the low voltage battery.

17. The method of claim 16, wherein the third threshold is an amount of change of the low voltage.

18. The method of claim 10, wherein the electrified vehicle further comprises a set of high voltage thermal systems that are powered by the high voltage system when enabled.
